(19) United States
(12) Patent Application Publication
(10) Pub. No.: US 2009/0151441 A1
(43) Pub. Date: Jun. 18, 2009

(54) TIRE PRESSURE ADJUSTING SYSTEM OF VEHICLE AND METHOD OF CONTROLLING THE SAME

(75) Inventors: Sungik Yim, Hwaseong-si (KR); Hoon Kim, Seoul (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/115,285

(22) Filed: May 5, 2008

(30) Foreign Application Priority Data
Dec. 15, 2007 (KR) 10-2007-0131798

(51) Int. Cl. B60C 23/02

(52) U.S. Cl. 73/146.2

(57) ABSTRACT

A tire pressure adjusting system of a vehicle includes: a sensor mounted in a tire, to measure pressure and/or temperature of air in the tire, and to send a signal corresponding to the pressure and/or temperature; a magnetic field generator mounted on the vehicle body near the tire, to receive the signal from the sensor, and to generate a magnetic field; a current generator mounted in the tire, to generate electricity by using the magnetic field; and an electric heating member mounted in the tire, to generate heat by using the electricity supplied from the current generator, thereby heating the air in the tire. A method of controlling tire pressure includes determining whether the pressure is too low; and, if the pressure is too low, heating air in the tire until the pressure is not too low.

### CROSS-REFERENCE TO RELATED APPLICATIONS

The present application is based on, and claims priority from, Korean Application Serial Number 10-2007-0131798, filed on Dec. 15, 2007, the disclosure of which is hereby incorporated by reference herein in its entirety.

### FIELD OF THE INVENTION

The present invention relates to a tire pressure adjusting system that automatically returns pressure to a normal level when the pressure is excessively low.

### BACKGROUND OF THE INVENTION

Tire pressure to should be optimized to ensure stability of travel, fuel efficiency, and vehicle durability. If tire pressure is too low, too much friction occurs between the tire and the road. Temperature of the air in the tire increases, which causes damage to the tire. The friction also causes fuel efficiency deterioration and the possibility of a tire blowout.

Tire Pressure Monitoring Systems (TPMSes) have been employed in recent years to address these problems. However, a typical TPMS merely informs a driver of temperature and pressure in the tire. It does not control the pressure.

The above information disclosed in this Background section is only for enhancement of understanding of the background of the invention and therefore it may contain information that does not form the prior art that is already known in this country to a person of ordinary skill in the art.

### SUMMARY OF THE INVENTION

A tire pressure adjusting system of a vehicle includes: a sensor mounted in a tire, to measure pressure and/or temperature of air in the tire, and to send a signal corresponding to the pressure and/or temperature; a magnetic field generator mounted on the vehicle body near the tire, to receive the signal from the sensor, and to generate a magnetic field; a current generator mounted in the tire, to generate electricity by using the magnetic field; and an electric heating member mounted in the tire, to generate heat by using the electricity supplied from the current generator, thereby heating the air in the tire.

A method of controlling tire pressure includes determining whether the pressure is too low; and, if the pressure is too low, heating air in the tire until the pressure is not too low. The method may heat the air by generating a magnetic field in a magnetic field generator, thereby generating electricity in a current generator; and supplying the electricity to an electric heating member. The method may further inform a user that the pressure is being controlled, during the heating step.

### BRIEF DESCRIPTION OF THE DRAWINGS

For a better understanding of the nature and objects of the present invention, reference should be made to the following detailed description with the accompanying drawings, in which:

FIG. 1 is a schematic view of a tire pressure adjusting system of a vehicle according to an embodiment of the present invention;

FIG. 2 illustrates the system of FIG. 1 during operation; and

FIG. 3 is a flow chart of a method of controlling a tire pressure adjusting system of a vehicle according to an embodiment of the present invention.

### DETAILED DESCRIPTION OF THE PREFERRED EMBODIMENTS

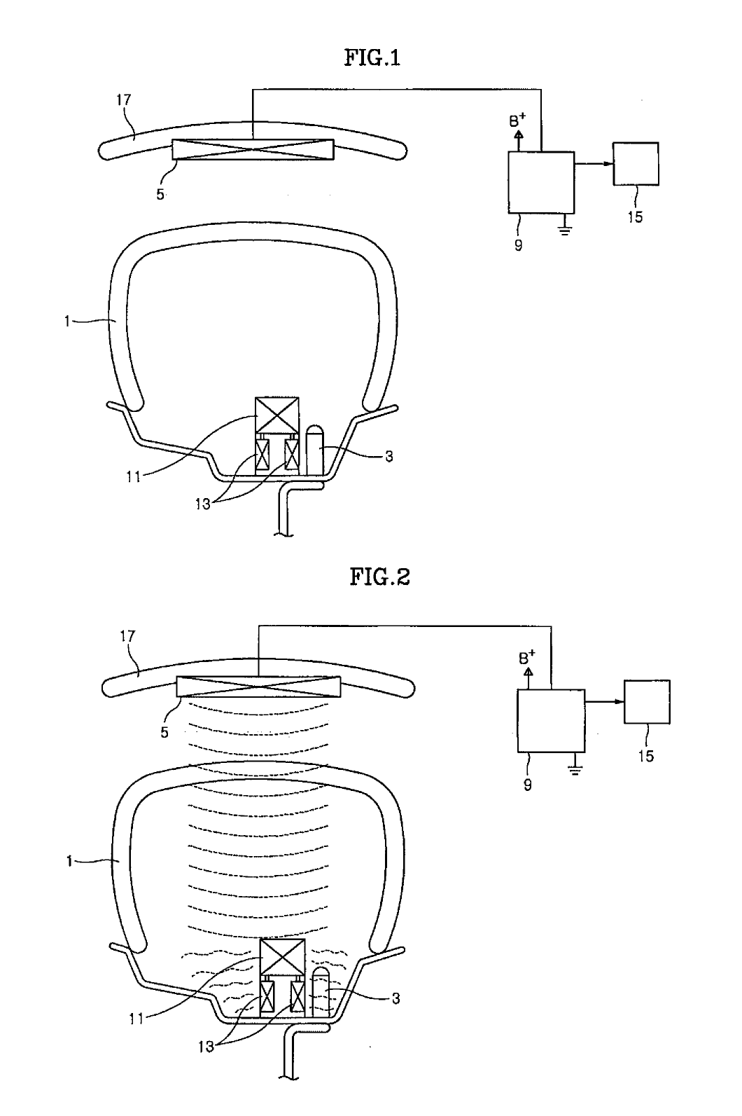

Referring to FIG. 1, a tire pressure adjusting system of a vehicle according to an embodiment of the present invention includes a TPMS sensor 3, a magnetic field generator such as a TPMS coil 5, a TPMS controller 9, a current generator such as an induced current generating coil 11, and an electric heating member 13. The TPMS sensor 3, which is provided in a tire 1, measures pressure and temperature in tire 1, and sends the pressure and temperature by a wireless signal. The TPMS coil 5 is provided on a vehicle body near the tire, and receives the signal from TPMS sensor 3. The TPMS controller 9 is electrically connected to TPMS coil 5. The induced current generating coil 11, which is provided in tire 1, generates electricity by using a magnetic field generated by TPMS coil 5. The electric heating member 13 generates heat by using the electricity supplied from induced current generating coil 11, and heats air in tire 1, thereby adjusting the tire pressure.

A display device 15, which is provided near the driver's seat, displays information about the pressure and the temperature of tire 1, and is electrically connected to TPMS controller 9. Display device 15 may inform the driver when the air pressure of tire 1 is insufficient, and that the air of tire 1 is being heated.

Induced current generating coil 11 and electric heating member 13 may be integral to one another, and mounted on a wheel in tire 1. TPMS coil 5 may be attached to a wheel housing 17 near tire 1.

In some embodiments, the TPMS sensor 3 may also be integral to the induced current generating coil 11 and electric heating member 13. This assembly may be easier to mount into the tire. However, in some embodiments, TPMS sensor 3 includes a temperature sensor. Therefore, it may be desirable to mount it some distance away from electric heating member 13. Therefore, in some embodiments, TPMS sensor 3 is provided separately from the induced current coil 11 and electric heating member 13. While the TPMS sensor 3 is illustrated just beside the induced current coil 11 and electric heating member 13, it may be spaced apart from the induced current coil 11 and the electric heating member 13 by any sufficient distance.

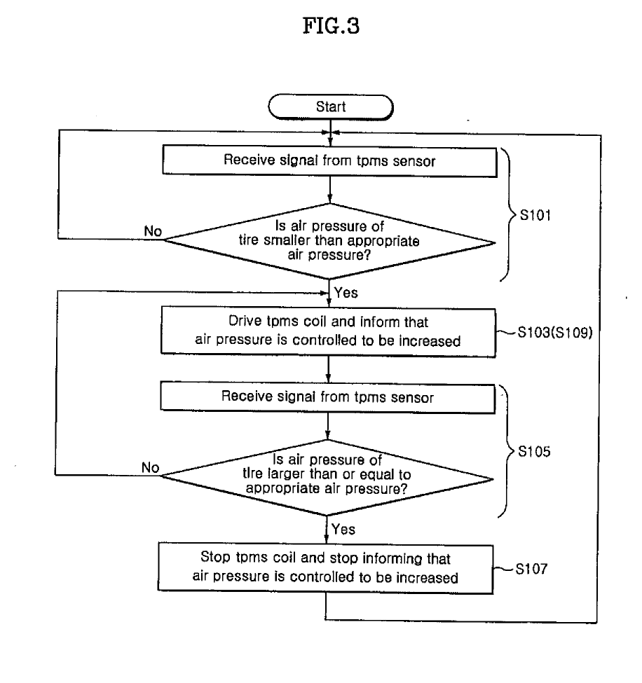

Referring to FIG. 3, a method of controlling a tire pressure adjusting system of a vehicle according to an embodiment of the present invention includes a pressure determining step S101 of receiving a signal, such as from TPMS sensor 3, and determining whether the pressure in tire 1 is too low. If the pressure is too low, a pressure increasing step S103 increases the pressure, such as by changing a magnetic field using TPMS coil 5, which generates electricity in induced current generating coil 11, which in turn causes heating member 13 to generate heat, increasing the pressure in the tire 1 (see also FIG. 2). An electric heat-pressure monitoring step S105 receives the signal from TPMS sensor 3 and repeatedly determines whether the air pressure in tire 1 is sufficient. A control ending step S107 stops the pressure increasing step S103 when it is determined that the pressure in tire 1 is sufficient.

The method may further include an information providing step S109, which informs the driver that the air pressure is being controlled, such as by display device 15. Step S109 may be concurrent with step S103.

Therefore, unlike in a typical TPMS, which may make the driver nervous due to the information about insufficient air pressure, the driver knows that the air pressure is being controlled, putting him at ease.

The information providing step S109 may stop when the air pressure in tire 1 is recovered to a normal level. Further, the normal air pressure of tire 1 may be displayed by display device 15, so that the driver normally drives the vehicle while being at ease.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A tire pressure adjusting system of a vehicle, comprising:
a sensor configured to be mounted in a tire, to measure at least one of pressure and temperature of air in the tire, and to send a signal corresponding to the pressure and/or temperature;
a magnetic field generator configured to be mounted on a vehicle body near the tire, to receive the signal from the sensor, and to generate a magnetic field;
a current generator configured to be mounted in the tire and to generate electricity by using the magnetic field; and
an electric heating member configured to be mounted in the tire and to generate heat by using the electricity supplied from the current generator, thereby heating the air in the tire.

2. A method of controlling a tire pressure, the method comprising:
determining whether a pressure in a tire is too low; and
if the pressure is too low, heating air in the tire until the pressure is not too low.

3. The method of claim 2, wherein the heating comprises generating a magnetic field in a magnetic field generator, thereby generating electricity in a current generator; and supplying the electricity to an electric heating member.

4. The method of claim 2, further comprising informing a user that the pressure is being controlled, during the heating step.
